(19) United States
(12) Patent Application Publication
(10) Pub. No.: US 2018/0040273 A1
(43) Pub. Date: Feb. 8, 2018

(54) SHIFT REGISTER UNIT, DRIVING METHOD, GATE DRIVING CIRCUIT AND DISPLAY APPARATUS

(71) Applicants: BOE Technology Group Co., Ltd., Beijing (CN); Chengdu BOE Optoelectronics Technology Co., Ltd., Chengdu (CN)

(72) Inventors: Wen Tan, Beijing (CN); Jia Chen, Beijing (CN)

(21) Appl. No.: 15/656,183

(22) Filed: Jul. 21, 2017

(30) Foreign Application Priority Data
Aug. 3, 2016 (CN) 201610630258.9

(51) Int. Cl. G09G 3/20

(52) U.S. Cl. CPC G09G 3/2092; G09G 2310/08; G09G 2310/0267; G09G 2310/0286; G09G 2330/02; G09G 2300/0809

(57) ABSTRACT

The embodiments of the present disclosure provide a shift register unit, a driving method, a gate driving circuit and a display apparatus. The shift register unit comprises: a first inverter unit; a second inverter unit, which comprises a control sub-unit and an inverter sub-unit; and a latch unit. The control sub-unit is configured to output a first power signal or a second power signal to the inverter sub-unit under control of a first node, a second node and a clock signal.

### CROSS-REFERENCE TO RELATED APPLICATION(S)

This application claims priority to the Chinese Patent Application No. 201610630258.9, filed on Aug. 3, 2016, entitled “SHIFT REGISTER UNIT, DRIVING METHOD, GATE DRIVING CIRCUIT AND DISPLAY APPARATUS,” which is incorporated herein by reference in its entirety.

### TECHNICAL FIELD

The present disclosure relates to display technology, and more particularly, to a shift register unit, a driving method, a gate driving circuit and a display apparatus.

### BACKGROUND

In order to display an image, a display apparatus uses a shift register (gate driving circuit) to scan pixel units. The shift register includes a number of shift register units each corresponding to one line of pixel units. With the shift register units, the pixel units of the display apparatus can be scanned on a per-line basis for displaying images. A conventional shift register unit incorporates devices such as an inverter, a three-state gate and a transmission gate to control high/low level of a driving signal outputted from the shift register unit. However, due to low noise tolerance of the inverter, when there is an input noise to such conventional shift register unit, the inverter may invert and then output the input noise, which may degrade the stability of the driving signal outputted from the shift register unit.

### SUMMARY

The embodiments of the present disclosure provide a shift register unit, a driving method, a gate driving circuit and a display apparatus.

According to a first aspect of the embodiments of the present disclosure, a shift register unit is provided. The shift register unit comprises: a first inverter unit connected to a clock signal terminal and a first node, and configured to control a level at the first node under control of a clock signal from the clock signal terminal; a second inverter unit connected to the clock signal terminal, the first node, a first power signal terminal, a second power signal terminal, an input signal terminal and a second node, and configured to output a first power signal from the first power signal terminal or a second power signal from the second power signal terminal to the second node under control of the clock signal, the first node and an input signal from the input signal terminal; and a latch unit connected to the first node, the second node, the clock signal terminal and an output signal terminal, and configured to control a level at the output signal terminal under control of the first node, the second node and the clock signal. The second inverter unit comprises: a control sub-unit and an inverter sub-unit. The control sub-unit is connected to the inverter sub-unit, the clock signal terminal, the first power signal terminal, the second power signal terminal and the second node, and configured to output the first power signal or the second power signal to the inverter sub-unit under control of the first node, the second node and the clock signal. The inverter sub-unit is connected to the control sub-unit, the first power signal terminal, the second power signal terminal, the input signal terminal and the second node, and configured to output the first power signal or the second power signal to the second node under control of the input signal and the control sub-unit.

For example, the control sub-unit comprises a first transistor and a second transistor. The first transistor has its first electrode connected to the second power signal terminal, its second electrode connected to the inverter sub-unit and its gate connected to the second node. The second transistor has its first electrode connected to the first power signal terminal, its second electrode connected to the inverter sub-unit and its gate connected to the second node.

For example, the inverter sub-unit comprises a third transistor, a fourth transistor, a fifth transistor and a sixth transistor. The third transistor has its first electrode connected to the first power signal terminal, its second electrode connected to a first electrode of the fourth transistor, and its gate connected to the input signal terminal. The fourth transistor has its first electrode connected to the second electrode of the third transistor and the second electrode of the first transistor, its second electrode connected to the second node, and its gate connected to the input signal terminal. The fifth transistor has its first electrode connected to the second power signal terminal, its second electrode connected to a first electrode of the sixth transistor, and its gate connected to the input signal terminal. The sixth transistor has its first electrode connected to the second electrode of the fifth transistor and the second electrode of the second transistor, its second electrode connected to the second node, and its gate connected to the input signal terminal.

For example, the control sub-unit further comprises a seventh transistor and an eighth transistor. The seventh transistor has its first electrode connected to the first power signal terminal, its second electrode connected to the first electrode of the third transistor, and its gate connected to the first node, the first electrode of the third transistor being connected to the first power signal terminal via the seventh transistor. The eighth transistor has its first electrode connected to the second power signal terminal, its second electrode connected to the first electrode of the fifth transistor, and its gate connected to the clock signal terminal, the first electrode of the fifth transistor being connected to the second power signal terminal via the eighth transistor.

For example, the control sub-unit further comprises a first transmission gate. The first transmission gate has its first control terminal connected to the clock signal terminal and its second control terminal connected to the first node. The first transmission gate has its input terminal connected to the second electrode of the fourth transistor, the gate of the first transistor, the second electrode of the sixth transistor and the gate of the second transistor, and its output terminal connected to the second node, the second electrode of the fourth transistor, the gate of the first transistor, the second electrode of the sixth transistor and the gate of the second transistor each being connected to the second node via the first transmission gate.

For example, the latch unit comprises a three-state gate and a first inverter. The three-stage gate has its first control terminal connected to the first node, its second control terminal connected to the clock signal terminal, its input terminal connected to the output signal terminal, and its output terminal connected to the second node. The first inverter has its input terminal connected to the second node, and its output terminal connected to the output signal terminal.

For example, the latch unit comprises a second inverter, a third inverter and a second transmission gate. The second inverter has its input terminal connected to the second node, and its output terminal connected to the output signal terminal. The third inverter has its input terminal connected to the output signal terminal, and its output terminal connected to an input terminal of the second transmission gate. The second transmission gate has its first control terminal connected to the first node, its second control terminal connected to the clock signal terminal, its input connected to the output terminal of the third inverter, and its output terminal connected to the second node.

For example, the first inverter unit comprises a fourth inverter having its input terminal connected to the clock signal terminal and its output terminal connected to the first node.

For example, the inverter sub-unit comprises at least one P-type transistor and at least one N-type transistor. The at least one P-type transistor is connected to the first power signal terminal, the input signal terminal, the control sub-unit and the second node, and configured to output the first power signal from the first power signal terminal to the second node under control of the input signal and the control sub-unit. The at least one N-type transistor is connected to the second power signal terminal, the input signal terminal, the control sub-unit and the second node, and configured to output the second power signal from the second power signal terminal to the second node under control of the input signal and the control sub-unit.

For example, each of the first transistor, the third transistor, the fourth transistor and the seventh transistor is a P-type transistor. Each of the second transistor, the fifth transistor, the sixth transistor and the eighth transistor is an N-type transistor.

According to a second aspect of the present disclosure, a method for driving the shift register unit according to the above first aspect is provided. The method comprises: a first period in which the input signal inputted to the input signal terminal is at a first level, the clock signal inputted to the clock signal terminal is at a second level, and the first inverter unit controls the first node to be at the first level and the second inverter unit to be in a high resistance state; a second period in which the input signal is maintained at the first level, the clock signal inputted to the clock signal terminal is at the first level, the second power signal inputted to the second power signal terminal is at the second level, the first inverter unit controls the first node to be at the second level, the second inverter unit outputs the second power signal to the second node, and the latch unit controls the output signal terminal to be at the first level; a third period in which the input signal inputted to the input signal terminal is at the second level, the clock signal inputted to the clock signal terminal is at the second level, the first inverter unit controls the first node to be at the first level, the second inverter unit is in the high resistance state, and the latch unit controls the output signal terminal to be maintained at the first level; and a fourth period in which the input signal is maintained at the second level, the clock signal inputted to the clock signal terminal is at the first level, the first power signal inputted to the first power signal terminal is at the first level, the first inverter unit controls the first node to be at the second level, the second inverter unit outputs the first power signal to the second node, and the latch unit controls the output signal terminal to be at the second level. The control sub-unit outputs the first power signal to the inverter sub-unit when the input signal transitions from the second level to the first level, and outputs the second power signal to the inverter sub-unit when the input signal transitions from the first level to the second level.

For example, the control sub-unit comprises a first transistor and a second transistor, and the inverter sub-unit comprises a third transistor, a fourth transistor, a fifth transistor and a sixth transistor. In the second period, the input signal is maintained at the first level, the fifth transistor and the sixth transistor are on, and the second power signal terminal outputs the second power signal to the second node. In the fourth period, the input signal is maintained at the second level, the third transistor and the fourth transistor are on, and the first power signal terminal outputs the first power signal to the second node. When the input signal transitions from the second level to the first level, the second transistor is on and the first power signal terminal outputs the first power signal to the first electrode of the sixth transistor. When the input signal transitions from the first level to the second level, the first transistor is on and the second power signal terminal outputs the second power signal to the first electrode of the fourth transistor.

For example, the control sub-unit further comprises a seventh transistor and an eighth transistor. In the first period and the third period, the clock signal is at the second level, the first node is at the first level, and the seventh transistor and the eighth transistor are off. In the second period and the fourth period, the clock signal is at the first level, the first node is at the second level, the seventh transistor and the eighth transistor are on, the first power signal terminal outputs the first power signal to the first electrode of the third transistor, and the second power signal terminal outputs the second power signal to the first electrode of the fifth transistor.

For example, the control sub-unit further comprises a first transmission gate. In the first period and the third period, the clock signal is at the second level, the first node is at the first level, and the first transmission gate is off. In the second period, the clock signal is at the first level, the first node is at the second level, the first transmission gate is on, and the second power signal terminal outputs the second power signal to the second node. In the fourth period, the clock signal is at the first level, the first node is at the second level, the first transmission gate is on, and the first power signal terminal outputs the first power signal to the second node.

For example, each of the first transistor, the third transistor and the fourth transistor is a P-type transistor. Each of the second transistor, the fifth transistor and the sixth transistor is an N-type transistor.

For example, the first level is a high level in relation to the second level.

According to a third aspect of the present disclosure, a gate driving circuit is provided. The gate driving circuit comprises at least two cascaded shift register units according to the above first aspect.

According to a fourth aspect of the present disclosure, a display apparatus is provided. The display apparatus comprises the gate driving circuit according to the above third aspect.

### BRIEF DESCRIPTION OF THE DRAWINGS

In order to illustrate the solutions according to the embodiments of the present disclosure clearly, the figures used for description of the embodiments will be introduced briefly here. It is apparent to those skilled in the art that the figures described below only illustrate some embodiments of the present disclosure and other figures can be obtained from these figures without applying any inventive skills.

FIG. 1 is a schematic diagram showing a structure of a shift register unit according to an embodiment of the present disclosure;

FIG. 2A is a schematic diagram showing a structure of a shift register unit according to another embodiment of the present disclosure;

FIG. 2B is a schematic diagram showing a structure of a shift register unit according to yet another embodiment of the present disclosure;

FIG. 2C is a schematic diagram showing a circuit structure of a conventional inverter in the related art;

FIG. 2D shows characteristic curves of output voltages vs. input voltages of a conventional inverter and a second inverter unit according to an embodiment of the present disclosure, respectively;

FIG. 3A is a flowchart illustrating a method for driving a shift register unit according to an embodiment of the present disclosure;

FIG. 3B is a driving timing sequence diagram of a shift register unit according to an embodiment of the present disclosure;

FIG. 3C is an operation timing sequence diagram of a conventional inverter with an input noise;

FIG. 3D is an operation timing sequence diagram of a shift register unit according to an embodiment of the present disclosure with an input noise; and

FIG. 4 is a schematic diagram showing a structure of a gate driving circuit according to an embodiment of the present disclosure.

### DETAILED DESCRIPTION OF THE EMBODIMENTS

In the following, the embodiments of the present disclosure will be described in further detail with reference to the figures, such that the objects, solutions and advantages of the present disclosure will become more apparent.

All the transistors used in the embodiments of the present disclosure can be Thin Film Transistors (TFTs) or Field Effect Transistors (FETs) or other devices having the same characteristics. The transistors used in the embodiments of the present disclosure are switching transistors, in accordance with their functions in circuits. The source and drain of each switching transistor used herein are interchangeable due to their symmetry. In the embodiments of the present disclosure, in order to distinguish between the two electrodes other than the gate in a transistor, the source can be referred to as a first electrode and the drain can be referred to as a second electrode. Accordingly, the gate of a transistor can be referred to as a third electrode. In each transistor shown in the figures, its middle terminal is the gate, its signal input terminal is the source and its signal output terminal is the drain. Further, the switching transistors used in the embodiments of the present disclosure include P-type switching transistors and N-type switching transistors. Each P-type switching transistor is turned on when its gate is at the low level and off when its gate is at the high level. Each N-type switching transistor is turned on when its gate is at the high level and off when its gate is at the low level. Further, some signals in the various embodiments of the present disclosure have a first level and a second level. Here the first level and the second level only mean that the level of the signal has two states, but do not imply any specific value of the first or second level. In the embodiments of the present disclosure, the first level is the high level and the second level is the low level. The first power signal can be at the low level and the second power signal can be at the high level.

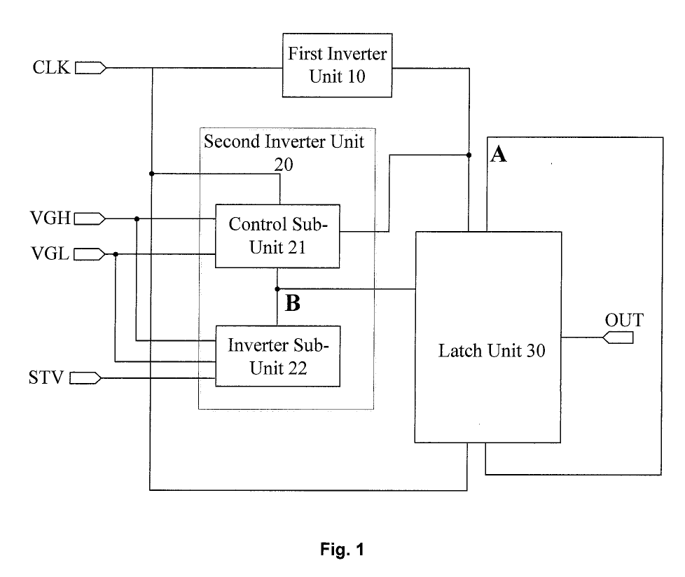

FIG. 1 is a schematic diagram showing a structure of a shift register unit according to an embodiment of the present disclosure. As shown in FIG. 1, the shift register unit includes a first inverter unit 10, a second inverter unit 20 and a latch unit 30.

The first inverter unit 10 is connected to a clock signal terminal, CLK, and a first node, A, and configured to control a level at the first node A under control of a clock signal from the clock signal terminal CLK.

The second inverter unit 20 is connected to the clock signal terminal CLK, the first node A, a first power signal terminal, VGH, a second power signal terminal, VGL, an input signal terminal, STV, and a second node, B, and configured to output a first power signal from the first power signal terminal VGH or a second power signal from the second power signal terminal VGL to the second node B under control of the clock signal, the first node A and an input signal from the input signal terminal STV.

The latch unit 30 is connected to the first node A, the second node B, the clock signal terminal CLK and an output signal terminal, OUT, and configured to control a level at the output signal terminal OUT under control of the first node A, the second node B and the clock signal CLK.

The second inverter unit 20 includes a control sub-unit 21 and an inverter sub-unit 22. The control sub-unit 21 is connected to the inverter sub-unit 22, the clock signal terminal CLK, the first power signal terminal VGH, the second power signal terminal VGL and the second node B, and configured to output the first power signal or the second power signal to the inverter sub-unit 22 under control of the first node A, the second node B and the clock signal. The inverter sub-unit 22 is connected to the control sub-unit 21, the first power signal terminal VGH, the second power signal terminal VGL, the input signal terminal SGV and the second node B, and configured to output the first power signal or the second power signal to the second node B under control of the input signal and the control sub-unit 21.

In summary, according to this embodiment of the present disclosure, a shift register unit is provided. The shift register unit includes a first inverter unit, a second inverter unit and a latch unit. The second inverter unit includes a control sub-unit and an inverter sub-unit. During transition of the level of the input signal, the control sub-unit can output a first power signal or a second power signal to the inverter sub-unit, so as to increase the noise tolerance of the inverter sub-unit and avoid impact on a driving signal outputted from the shift register unit when the input signal contains noise. In this way, the anti-noise performance of the shift register unit can be improved.

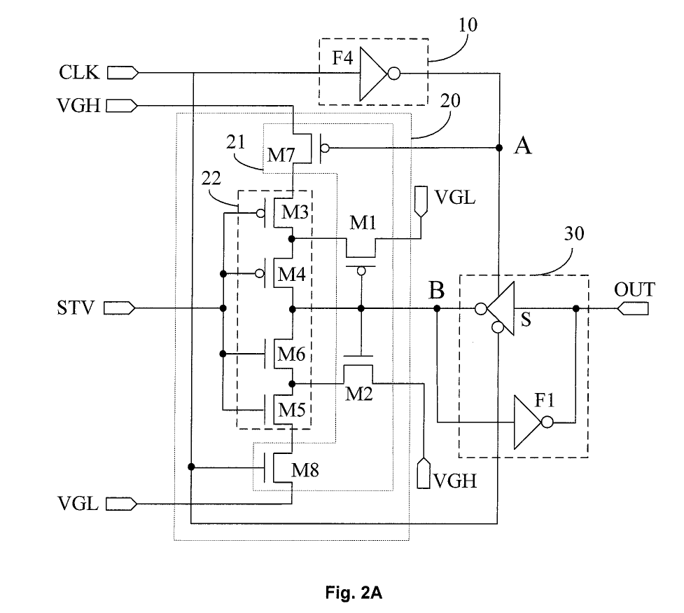

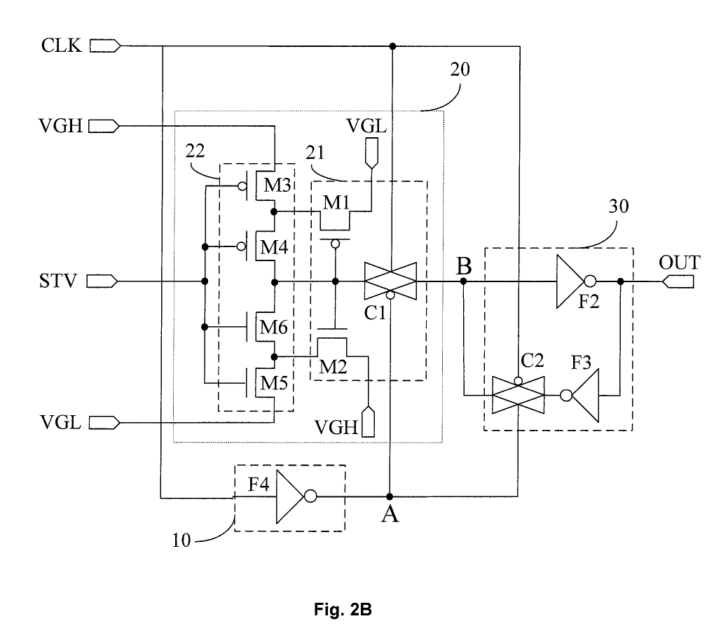

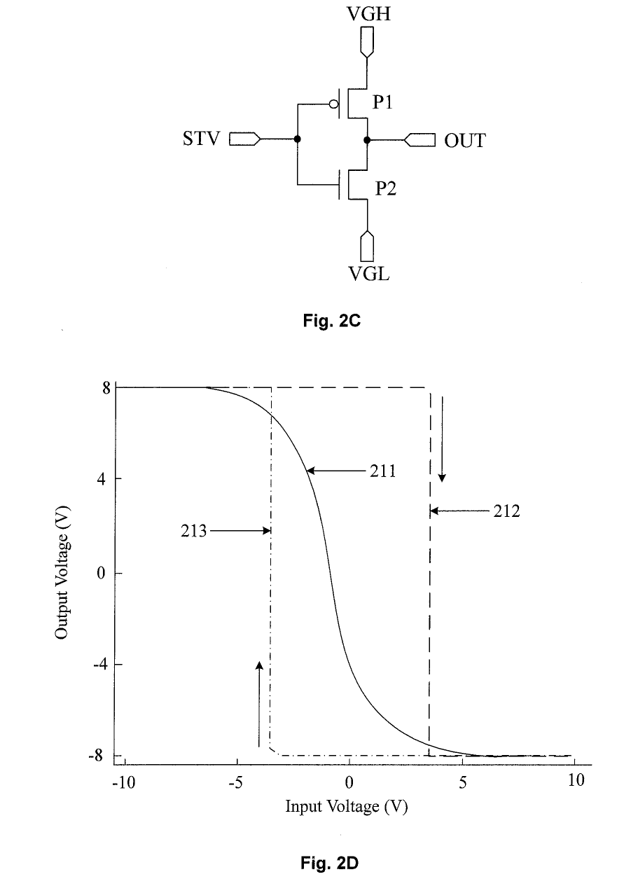

FIG. 2A is a schematic diagram showing a structure of a shift register unit according to another embodiment of the present disclosure. FIG. 2B is a schematic diagram showing a structure of a shift register unit according to yet another embodiment of the present disclosure. Referring to FIG. 2A and FIG. 2B, the control sub-unit 21 can include a first transistor M1 and a second transistor M2.

The first transistor M1 has its first electrode connected to the second power signal terminal VGL, its second electrode connected to the inverter sub-unit 22 and its gate connected to the second node B.

The second transistor M2 has its first electrode connected to the first power signal terminal VGH, its second electrode connected to the inverter sub-unit 22 and its gate connected to the second node B.

For example, as shown in FIG. 2A and FIG. 2B, the inverter sub-unit 22 can include a third transistor M3, a fourth transistor M4, a fifth transistor M5 and a sixth transistor M6.

The third transistor M3 has its first electrode connected to the first power signal terminal VGH, its second electrode connected to a first electrode of the fourth transistor M4, and its gate connected to the input signal terminal STV.

The fourth transistor M4 has its first electrode connected to the second electrode of the third transistor M3 and the second electrode of the first transistor M1, its second electrode connected to the second node B, and its gate connected to the input signal terminal STV.

The fifth transistor M5 has its first electrode connected to the second power signal terminal VGL, its second electrode connected to a first electrode of the sixth transistor M6, and its gate connected to the input signal terminal STV.

The sixth transistor M6 has its first electrode connected to the second electrode of the fifth transistor M5 and the second electrode of the second transistor M2, its second electrode connected to the second node B, and its gate connected to the input signal terminal STV.

FIG. 2C is a schematic diagram showing a circuit structure of a conventional inverter. As shown in FIG. 2C, the inverter consists of a P-type transistor P1 and an N-type transistor P2. Referring to FIG. 2C, when the signal at the input signal terminal STV is at the high level, the N-type transistor P2 is on, the second power signal terminal VGL outputs the second power signal at a second level to the output terminal OUT. When the signal at the input signal terminal STV is at the low level, the P-type transistor P1 is on, the first power signal terminal VGH outputs the first power signal at a first level to the output terminal OUT. The first level is the high level in relation to the second level. Hence, the inverter can invert the level of the input signal.

Referring to FIGS. 2A and 2B, in the second inverter unit according to the embodiment of the present disclosure, when the input signal inputted at the input terminal STV is at the first level, the fifth transistor M5 and the sixth transistor M6 are on, and the second power signal terminal VGL outputs the second power signal at the second level to the second node B. At this time, the first transistor M1 is on. When the input signal changes from the first level to the second level, the third transistor M3 and the fourth transistor M4 are gradually turned on and the first power signal terminal VGH gradually outputs the first power signal to the second node. Meanwhile, during the change of the input signal, when the third transistor M3 and the fourth transistor M4 have not been fully on, the first transistor M1 can remain on and output the second power signal to the first electrode of the fourth transistor M4, such that the transition of the level at the second node B can be slowed down. The level at the second node B can transition from low to high only when the level of the input signal is low enough to fully turn on the third transistor M3 and the fourth transistor M4 and the first transistor M1 is fully off. When the input signal changes from the second level to the first level, the second transistor M2 can also slow down the transition of the level at the second node B. Accordingly, when compared with the conventional inverter as shown in FIG. 2C, the second inverter unit 20 in this embodiment has a higher noise tolerance.

FIG. 2D shows characteristic curves of output voltages vs. input voltages of the conventional inverter and the second inverter unit according to the embodiment of the present disclosure, respectively. As shown, the curve 211 is a characteristic curve of output voltage vs. input voltage of the conventional inverter, the curve 212 is a characteristic curve of output voltage vs. input voltage of the second inverter unit when the input voltage changes from low to high, and the dashed curve 213 is a characteristic curve of output voltage vs. input voltage of the second inverter unit when the input voltage changes from high to low. It can be seen from the curve 211 that, the output voltage changes from high to low as the input voltage changes from low to high (i.e., from the negative VGL to the positive VGH), and from low to high as the input voltage changes from high to low (i.e., from the positive VGH to the negative VGL). The conventional inverter can achieve the high-low switching of the output voltage when its input voltage is approximately −1V. It can be seen from the curve 212 that, during the change of the input voltage from low to high, the output voltage may transition from high to low when the input voltage is approximately 4V. It can be seen from the dashed curve 213 that, during the change of the input voltage from high to low, the output voltage may transition from low to high when the input voltage is approximately −4V.

Referring to FIG. 2C, when the input voltage changes from low to high, the second inverter unit according to the embodiment of the present disclosure requires a higher input voltage than the conventional inverter to switch the output voltage from high to low. When the input voltage changes from high to low, the second inverter unit according to the embodiment of the present disclosure requires a lower input voltage than the conventional inverter to switch the output voltage from low to high. Therefore, when the input signal to the shift register unit contains noise, the second inverter unit according to the embodiment of the present disclosure will not invert and output the noise signal due to its higher noise tolerance. Accordingly, the stability of the driving signal outputted from the shift register unit will not be influenced and the anti-noise performance of the shift register unit can be improved.

In an exemplary implementation, as shown in FIG. 2A, the control sub-unit 21 can further include a seventh transistor M7 and an eighth transistor M8. The seventh transistor M7 has its first electrode connected to the first power signal terminal VGH, its second electrode connected to the first electrode of the third transistor M3, and its gate connected to the first node A. The first electrode of the third transistor M3 is connected to the first power signal terminal VGH via the seventh transistor M7.

The eighth transistor M8 has its first electrode connected to the second power signal terminal VGL, its second electrode connected to the first electrode of the fifth transistor M5, and its gate connected to the clock signal terminal CLK. The first electrode of the fifth transistor M5 is connected to the second power signal terminal VGL via the eighth transistor M8.

Alternatively, in an exemplary implementation, as shown in FIG. 2B, the control sub-unit 21 can further include a first transmission gate C1.

The first transmission gate C1 has its first control terminal connected to the clock signal terminal CLK and its second control terminal connected to the first node A.

The first transmission gate C1 has its input terminal connected to the second electrode of the fourth transistor M4, the gate of the first transistor M1, the second electrode of the sixth transistor M6 and the gate of the second transistor M2, and its output terminal connected to the second node B. the second electrode of the fourth transistor M4, the gate of the first transistor M1, the second electrode of the sixth transistor M6 and the gate of the second transistor m2 are each connected to the second node B via the first transmission gate C1.

Further, the latch unit in the shift register unit according to the embodiment of the present disclosure may have two exemplary structures. In an example, as shown in FIG. 2A, the latch unit 30 can include a three-state gate S and a first inverter F1.

The three-stage gate S has its first control terminal connected to the first node A, its second control terminal connected to the clock signal terminal CLK, its input terminal connected to the output signal terminal OUT, and its output terminal connected to the second node B.

The first inverter F1 has its input terminal connected to the second node B, and its output terminal connected to the output signal terminal OUT.

In another example, as shown in FIG. 2B, the latch unit 30 can further include a second inverter F2, a third inverter F3 and a second transmission gate C2.

The second inverter F2 has its input terminal connected to the second node B, and its output terminal connected to the output signal terminal OUT.

The third inverter F3 has its input terminal connected to the output signal terminal OUT, and its output terminal connected to an input terminal of the second transmission gate C2.

The second transmission gate C2 has its first control terminal connected to the first node A, its second control terminal connected to the clock signal terminal CLK, its input connected to the output terminal of the third inverter F3, and its output terminal connected to the second node B.

For example, referring to FIGS. 2A and 2B, the first inverter unit 10 in the shift register unit can include a fourth inverter F4 having its input terminal connected to the clock signal terminal CLK and its output terminal connected to the first node A.

For example, in an embodiment of the present disclosure, the inverter sub-unit 22 can further include at least one P-type transistor and at least one N-type transistor.

The at least one P-type transistor is connected to the first power signal terminal VGH, the input signal terminal STV, the control sub-unit 21 and the second node B, and configured to output the first power signal from the first power signal terminal VGH to the second node B under control of the input signal and the control sub-unit 21.

The at least one N-type transistor is connected to the second power signal terminal VGL, the input signal terminal STV, the control sub-unit 21 and the second node B, and configured to output the second power signal from the second power signal terminal VGL to the second node B under control of the input signal and the control sub-unit 21.

It is to be noted here that, in the embodiments of the present disclosure, each of the first transistor M1, the third transistor M3, the fourth transistor M4 and the seventh transistor M7 can be a P-type transistor, and each of the second transistor M2, the fifth transistor M5, the sixth transistor M6 and the eighth transistor M8 can be an N-type transistor.

In summary, according to this embodiment of the present disclosure, a shift register unit is provided. The shift register unit includes a first inverter unit, a second inverter unit and a latch unit. The second inverter unit includes a control sub-unit and an inverter sub-unit. During transition of the level of the input signal, the control sub-unit can output a first power signal or a second power signal to the inverter sub-unit, so as to increase the noise tolerance of the inverter sub-unit and avoid impact on a driving signal outputted from the shift register unit when the input signal contains noise. In this way, the anti-noise performance of the shift register unit can be improved.

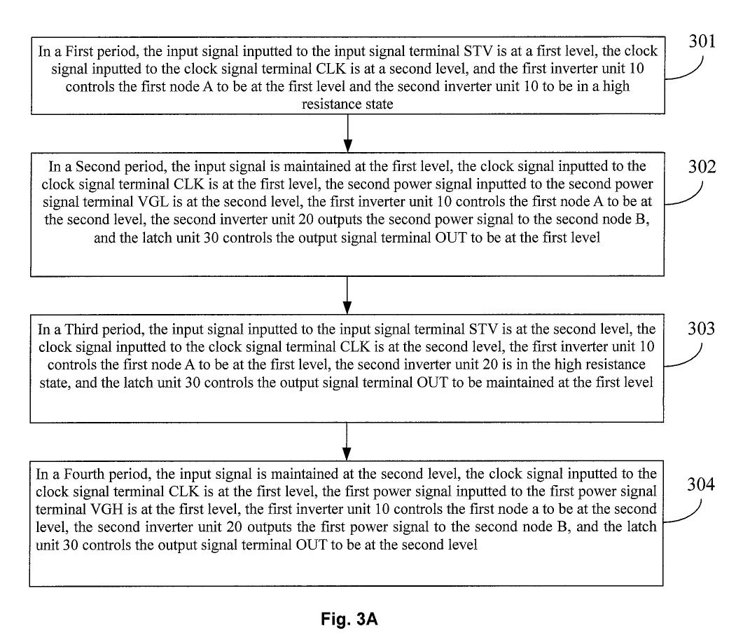

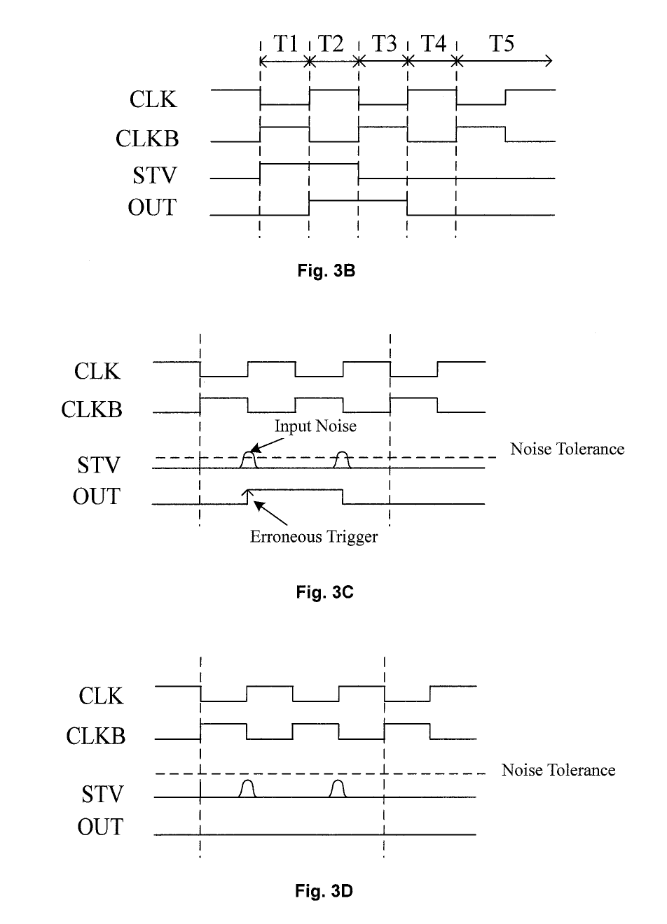

FIG. 3A is a flowchart illustrating a method for driving a shift register unit according to an embodiment of the present disclosure. The method can be used to drive the shift register unit shown in FIG. 1, 2A or 2B. Referring to FIG. 3A, the method can include the following steps.

At step 301, in a first period, the input signal inputted to the input signal terminal STV is at a first level, the clock signal inputted to the clock signal terminal CLK is at a second level, and the first inverter unit 10 controls the first node A to be at the first level and the second inverter unit 10 to be in a high resistance state.

At step 302, in a second period, the input signal is maintained at the first level, the clock signal inputted to the clock signal terminal CLK is at the first level, the second power signal inputted to the second power signal terminal VGL is at the second level, the first inverter unit 10 controls the first node A to be at the second level, the second inverter unit 20 outputs the second power signal to the second node B, and the latch unit 30 controls the output signal terminal OUT to be at the first level.

At step 303, in a third period, the input signal inputted to the input signal terminal STV is at the second level, the clock signal inputted to the clock signal terminal CLK is at the second level, the first inverter unit 10 controls the first node A to be at the first level, the second inverter unit 20 is in the high resistance state, and the latch unit 30 controls the output signal terminal OUT to be maintained at the first level.

At step 304, in a fourth period, the input signal is maintained at the second level, the clock signal inputted to the clock signal terminal CLK is at the first level, the first power signal inputted to the first power signal terminal VGH is at the first level, the first inverter unit 10 controls the first node a to be at the second level, the second inverter unit 20 outputs the first power signal to the second node B, and the latch unit 30 controls the output signal terminal OUT to be at the second level.

The control sub-unit 21 outputs the first power signal to the inverter sub-unit 22 when the input signal transitions from the second level to the first level, and outputs the second power signal to the inverter sub-unit 22 when the input signal transitions from the first level to the second level.

In summary, according to this embodiment of the present disclosure, a method for driving a shift register unit. During transition of the level of the input signal, the control sub-unit can output a first power signal or a second power signal to the inverter sub-unit, so as to increase the noise tolerance of the inverter sub-unit and avoid impact on a driving signal outputted from the shift register unit when the input signal contains noise. In this way, the anti-noise performance of the shift register unit can be improved.

For example, referring to FIGS. 2-1 and 2-2, the control sub-unit 21 can include a first transistor M1 and a second transistor M2, and the inverter sub-unit 22 can include a third transistor M3, a fourth transistor M4, a fifth transistor M5 and a sixth transistor M6.

In the second period, the input signal is maintained at the first level, the fifth transistor M5 and the sixth transistor M6 are on, and the second power signal terminal VGL outputs the second power signal to the second node B.

In the fourth period, the input signal is maintained at the second level, the third transistor M3 and the fourth transistor M4 are on, and the first power signal terminal VGH outputs the first power signal to the second node B.

When the input signal transitions from the second level to the first level, the second transistor M2 is on and the first power signal terminal VGH outputs the first power signal to the first electrode of the sixth transistor M6. When the input signal transitions from the first level to the second level, the first transistor M1 is on and the second power signal terminal VGL outputs the second power signal to the first electrode of the fourth transistor M4.

For example, as shown in FIG. 2A, the control sub-unit 21 further includes a seventh transistor M7 and an eighth transistor M8. The latch unit 30 can include a three-state gate S and a first inverter F1. The first inverter unit 10 can include a fourth inverter F4.

FIG. 3B is a driving timing sequence diagram of a shift register unit according to an embodiment of the present disclosure. The process for driving the shift register unit, e.g., the shift register unit shown in FIG. 2A, will be explained in detail.

As shown in FIG. 3B, in the first period T1, the input signal is at the first level, the fifth transistor M5 and the sixth transistor M6 are on, and the clock signal is at the second level. With the fourth inverter F4, the first node A is at the first level and the seventh transistor M7 and the eighth transistor M8 are off. Since the eighth transistor M8 is off, the fifth transistor M5 and the sixth transistor M6 cannot output the second power signal to the second node B. Thus, in the first period T1, the second inverter unit 20 is in the high resistance state and the output terminal OUT is at the second level.

In the second period T2, the input signal is at the first level. The fifth transistor M5 and the sixth transistor M6 are on and the clock signal is at the first level. With the fourth inverter F4, the first node A is at the second level, the seventh transistor M7 and the eighth transistor M8 are on, and the second power signal terminal VGL outputs the second power signal at the second level to the second node B via the fifth transistor M5 and the sixth transistor M6. With the first inverter F1, in the second period T2, the output terminal OUT is at the first level.

In the third period T3, the input signal is at the second level and the third transistor M3 and the fourth transistor M4 are on. However, since the clock signal is at the second level, the first node A is at the first level, such that the seventh transistor M7 is off and the third transistor M3 and the fourth transistor M4 cannot output the first power signal to the second node B. Hence, in the third period T3, the second inverter unit 20 is in the high resistance state. However, since at this time the clock signal is at the second level, the first node A is at the first level and the three-state gate S is on. With the three-state gate S and the first inverter F1 in the hatch unit 30, the output terminal OUT is maintained at the first level.

In the fourth period T4, the input signal is at the second level, the third transistor M3 and the fourth transistor M4 are on and the clock signal is at the first level. With the fourth inverter F4, the first node A is at the second level, the seventh transistor M7 and the eighth transistor M8 are on, and the first power signal terminal VGH outputs the first power signal at the first level to the second node B via the third transistor M3. With the first inverter F1 (the three-state gate S is off in this case), the output terminal OUT is at the second level in the fourth period T4.

For example, as shown in FIG. 2-2, the control sub-unit further includes a first transmission gate C1. The latch unit can further include a second inverter F2, a third inverter F3 and a second transmission gate C2.

In the first period, the clock signal is at the second level, the first node A is at the first level and the first transmission gate C1 is off. Hence, neither of the first power signal terminal VGH and the second power signal terminal VGL can output a signal to the second node B. In the first period T1, the second inverter unit 20 is in the high resistance state.

In the second period T2, the clock signal is in the first level, the first node A is at the second level, and the first transmission gate C1 is on. Since at this time the input signal is at the first level, the fifth transistor M5 and the sixth transistor M6 are on, and the second power signal terminal VGL can output the second power signal to the second node B. With the second inverter F2 (the second transmission gate C2 is off in this case), the output terminal OUT is at the first level.

In the third period T3, the clock signal is at the second level, the first node A is at the first level, and the first transmission gate C1 is off. Accordingly, neither of the first power signal terminal VGH and the second power signal terminal VGL can output a signal to the second node B. Hence in the third period T3, the second inverter unit 20 is in the high resistance state. However, since in the third period T3 the second transmission gate C2 is on, with the second transmission gate C2, the second inverter F2 and the third inverter F3 in the latch unit 30, the output terminal OUT is maintained at the first level.

In the fourth period T4, the clock signal is at the first level, the first node A is at the second level, and the firs transmission gate C1 is on. Since at this time the input signal is at the second level, the third transistor M3 and the fourth transistor M4 are on and the first power signal terminal VGH can output the first power signal to the second node B. With the second inverter F2, the output terminal OUT is at the second level.

After the fourth period and before the scanning for the next frame starts, the fifth period T5 can be repeated in the shift register unit. It can be seen from FIG. 3B that, in the fifth period T5, the signal inputted to the input signal terminal STV and the signal outputted from the output signal terminal OUT are both at the second level.

FIG. 3C is an operation timing sequence diagram of a conventional inverter with an input noise. Due to the low tolerance of the conventional inverter (or conventional three-state gate) for input noise, when the clock signal inputted at the clock signal terminal CLK is at the high level and the input signal inputted at the input signal terminal STV contains noise higher than the noise tolerance, the conventional inverter will invert and output the input noise, such that the output signal from the output terminal OUT of the shift register unit is switched from the low level to the high level. If at this time the clock signal transitions from the high level to the low level, the high level at the output terminal, which is triggered by the input noise erroneously, will be latched in the latch unit. Hence, the output terminal OUT of the shift register unit will output the high level, which causes shift outputs stage by stage in a shift register (or gate driving circuit), resulting in malfunctions of the gate driving circuit.

FIG. 3D is an operation timing sequence diagram of a shift register unit according to an embodiment of the present disclosure with an input noise. It can be seen from FIG. 3D that, since the second inverter unit has a higher noise tolerance, when the clock signal inputted at the clock signal terminal CLK is at the first level and the input signal inputted at the input signal terminal STV contains an input noise, the second inverter unit can maintain an appropriate noise tolerance by adjusting parameters of the respective elements in the second inverter unit. In this way, it is possible to avoid the level of the output signal from the second inverter unit to be switched, such that the output signal from the output terminal OUT of the shift register unit will not be triggered by the input noise erroneously and the reliability of the shift register unit can thus be improved effectively.

It is to be note here that the above embodiments have been described assuming the first transistor M1, the third transistor M3, the fourth transistor M4 and the seventh transistor M7 to be P-type transistors, the second transistor M2, the fifth transistor M5, the sixth transistor M6 and the eighth transistor M8 to be N-type transistors, the first level to be the high level and the second level to be the low level. However, the first transistor M1, the third transistor M3, the fourth transistor M4 and the seventh transistor M7 can be P-type transistors, and the second transistor M2, the fifth transistor M5, the sixth transistor M6 and the eighth transistor M8 can be N-type transistors. When the first transistor M1, the third transistor M3, the fourth transistor M4 and the seventh transistor M7 are P-type transistors and the second transistor M2, the fifth transistor M5, the sixth transistor M6 and the eighth transistor M8 are N-type transistors, the first level can be the low level and the second level can be the high level, and the variations of the levels of the first clock signal terminal CLK and the input signal terminal STV can be opposite to those shown in FIG. 3-2, i.e., with a phase difference of 180 degrees.

In summary, according to this embodiment of the present disclosure, a method for driving a shift register unit. During transition of the level of the input signal, the control sub-unit can output a first power signal or a second power signal to the inverter sub-unit, so as to increase the noise tolerance of the inverter sub-unit and avoid impact on a driving signal outputted from the shift register unit when the input signal contains noise. In this way, the anti-noise performance of the shift register unit can be improved.

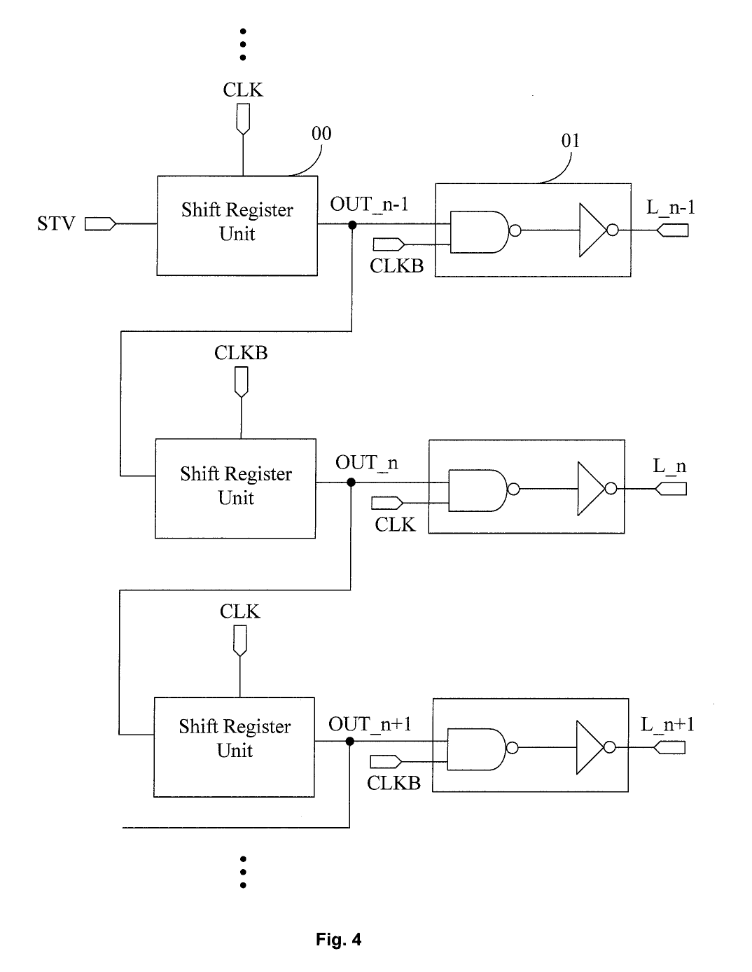

Referring to FIG. 4, according to an embodiment of the present disclosure, a gate driving circuit is provided. The gate driving circuit includes at least two cascaded shift register units 00. Each shift register unit has its output signal terminal connected to an output control unit 01. The output signal from each output control unit 01 is used for driving a line of pixels. The input signal terminal of the shift register unit at each stage is connected to the output signal terminal of the shift register unit at the previous stage. For example, the input signal terminal of the shift register unit at the n-th stage is connected to the output signal terminal, OUT_n−1, of the shift register unit at the (n−1)-th stage. Here, each shift register unit 00 can be the shift register unit as shown in FIG. 1, 2A or 2C. Each output control unit 01 can include a NAND gate and an inverter.

Moreover, according to an embodiment of the present disclosure, a display apparatus is provided. The display apparatus includes the gate driving circuit as shown in FIG. 4. The display apparatus can be an LCD panel, e-paper, Organic Light Emitting Diode (OLED) panel, mobile phone, tablet computer, television, display, notebook computer, digital frame, navigator or any other products or components having display functions.

While the embodiments of the present invention have been described above, the scope of the present invention is not limited thereto. Various modifications, alternatives and improvements can be made by those skilled in the art without departing from the scope of the present disclosure. These modifications, alternatives and improvements are to be encompassed by the scope of the present invention.

What is claimed is:

1. A shift register unit, comprising:
a first inverter unit connected to a clock signal terminal and a first node, and configured to control a level at the first node under control of a clock signal from the clock signal terminal;
a second inverter unit connected to the clock signal terminal, the first node, a first power signal terminal, a second power signal terminal, an input signal terminal and a second node, and configured to output a first power signal from the first power signal terminal or a second power signal from the second power signal terminal to the second node under control of the clock signal, the first node and an input signal from the input signal terminal; and
a latch unit connected to the first node, the second node, the clock signal terminal and an output signal terminal, and configured to control a level at the output signal terminal under control of the first node, the second node and the clock signal,
wherein the second inverter unit comprises: a control sub-unit and an inverter sub-unit,
the control sub-unit is connected to the inverter sub-unit, the clock signal terminal, the first power signal terminal, the second power signal terminal and the second node, and configured to output the first power signal or the second power signal to the inverter sub-unit under control of the first node, the second node and the clock signal, and
the inverter sub-unit is connected to the control sub-unit, the first power signal terminal, the second power signal terminal, the input signal terminal and the second node, and configured to output the first power signal or the second power signal to the second node under control of the input signal and the control sub-unit.

2. The shift register unit of claim 1, wherein the control sub-unit comprises a first transistor and a second transistor, wherein
the first transistor has its first electrode connected to the second power signal terminal, its second electrode connected to the inverter sub-unit and its gate connected to the second node, and
the second transistor has its first electrode connected to the first power signal terminal, its second electrode connected to the inverter sub-unit and its gate connected to the second node.

3. The shift register unit of claim 2, wherein the inverter sub-unit comprises a third transistor, a fourth transistor, a fifth transistor and a sixth transistor, wherein
the third transistor has its first electrode connected to the first power signal terminal, its second electrode connected to a first electrode of the fourth transistor, and its gate connected to the input signal terminal,
the fourth transistor has its first electrode connected to the second electrode of the third transistor and the second electrode of the first transistor, its second electrode connected to the second node, and its gate connected to the input signal terminal,
the fifth transistor has its first electrode connected to the second power signal terminal, its second electrode connected to a first electrode of the sixth transistor, and its gate connected to the input signal terminal, and
the sixth transistor has its first electrode connected to the second electrode of the fifth transistor and the second electrode of the second transistor, its second electrode connected to the second node, and its gate connected to the input signal terminal.

4. The shift register unit of claim 3, wherein the control sub-unit further comprises a seventh transistor and an eighth transistor, wherein
the seventh transistor has its first electrode connected to the first power signal terminal, its second electrode connected to the first electrode of the third transistor, and its gate connected to the first node, the first electrode of the third transistor being connected to the first power signal terminal via the seventh transistor, and
the eighth transistor has its first electrode connected to the second power signal terminal, its second electrode connected to the first electrode of the fifth transistor, and its gate connected to the clock signal terminal, the first electrode of the fifth transistor being connected to the second power signal terminal via the eighth transistor.

5. The shift register unit of claim 3, wherein the control sub-unit further comprises a first transmission gate, wherein
the first transmission gate has its first control terminal connected to the clock signal terminal and its second control terminal connected to the first node, and
the first transmission gate has its input terminal connected to the second electrode of the fourth transistor, the gate of the first transistor, the second electrode of the sixth transistor and the gate of the second transistor, and its output terminal connected to the second node, the second electrode of the fourth transistor, the gate of the first transistor, the second electrode of the sixth transistor and the gate of the second transistor each being connected to the second node via the first transmission gate.

6. The shift register unit of claim 1, wherein the latch unit comprises a three-state gate and a first inverter, wherein
the three-stage gate has its first control terminal connected to the first node, its second control terminal connected to the clock signal terminal, its input terminal connected to the output signal terminal, and its output terminal connected to the second node,
the first inverter has its input terminal connected to the second node, and its output terminal connected to the output signal terminal.

7. The shift register unit of claim 1, wherein the latch unit comprises a second inverter, a third inverter and a second transmission gate,
the second inverter has its input terminal connected to the second node, and its output terminal connected to the output signal terminal,
the third inverter has its input terminal connected to the output signal terminal, and its output terminal connected to an input terminal of the second transmission gate, and
the second transmission gate has its first control terminal connected to the first node, its second control terminal connected to the clock signal terminal, its input connected to the output terminal of the third inverter, and its output terminal connected to the second node.

8. The shift register unit of claim 1, wherein the first inverter unit comprises a fourth inverter having its input terminal connected to the clock signal terminal and its output terminal connected to the first node.

9. The shift register unit of claim 1, wherein the inverter sub-unit comprises at least one P-type transistor and at least one N-type transistor, wherein
the at least one P-type transistor is connected to the first power signal terminal, the input signal terminal, the control sub-unit and the second node, and configured to output the first power signal from the first power signal terminal to the second node under control of the input signal and the control sub-unit, and
the at least one N-type transistor is connected to the second power signal terminal, the input signal terminal, the control sub-unit and the second node, and configured to output the second power signal from the second power signal terminal to the second node under control of the input signal and the control sub-unit.

10. The shift register unit of claim 4, wherein
each of the first transistor, the third transistor, the fourth transistor and the seventh transistor is a P-type transistor, and
each of the second transistor, the fifth transistor, the sixth transistor and the eighth transistor is an N-type transistor.

11. A method for driving the shift register unit according to claim 1, comprising:
a first period in which the input signal inputted to the input signal terminal is at a first level, the clock signal inputted to the clock signal terminal is at a second level, and the first inverter unit controls the first node to be at the first level and the second inverter unit to be in a high resistance state;
a second period in which the input signal is maintained at the first level, the clock signal inputted to the clock signal terminal is at the first level, the second power signal inputted to the second power signal terminal is at the second level, the first inverter unit controls the first node to be at the second level, the second inverter unit outputs the second power signal to the second node, and the latch unit controls the output signal terminal to be at the first level;
a third period in which the input signal inputted to the input signal terminal is at the second level, the clock signal inputted to the clock signal terminal is at the second level, the first inverter unit controls the first node to be at the first level, the second inverter unit is in the high resistance state, and the latch unit controls the output signal terminal to be maintained at the first level; and
a fourth period in which the input signal is maintained at the second level, the clock signal inputted to the clock signal terminal is at the first level, the first power signal inputted to the first power signal terminal is at the first level, the first inverter unit controls the first node to be at the second level, the second inverter unit outputs the first power signal to the second node, and the latch unit controls the output signal terminal to be at the second level,
wherein the control sub-unit outputs the first power signal to the inverter sub-unit when the input signal transitions from the second level to the first level, and outputs the second power signal to the inverter sub-unit when the input signal transitions from the first level to the second level.

12. The method of claim 11, wherein the control sub-unit comprises a first transistor and a second transistor, and the inverter sub-unit comprises a third transistor, a fourth transistor, a fifth transistor and a sixth transistor, wherein
in the second period, the input signal is maintained at the first level, the fifth transistor and the sixth transistor are on, and the second power signal terminal outputs the second power signal to the second node,
in the fourth period, the input signal is maintained at the second level, the third transistor and the fourth transistor are on, and the first power signal terminal outputs the first power signal to the second node,
when the input signal transitions from the second level to the first level, the second transistor is on and the first power signal terminal outputs the first power signal to the first electrode of the sixth transistor, and
when the input signal transitions from the first level to the second level, the first transistor is on and the second power signal terminal outputs the second power signal to the first electrode of the fourth transistor.

13. The method of claim 12, wherein the control sub-unit further comprises a seventh transistor and an eighth transistor, wherein
in the first period and the third period, the clock signal is at the second level, the first node is at the first level, and the seventh transistor and the eighth transistor are off, and
in the second period and the fourth period, the clock signal is at the first level, the first node is at the second level, the seventh transistor and the eighth transistor are on, the first power signal terminal outputs the first power signal to the first electrode of the third transistor, and the second power signal terminal outputs the second power signal to the first electrode of the fifth transistor.

14. The method of claim 12, wherein the control sub-unit further comprises a first transmission gate, wherein
in the first period and the third period, the clock signal is at the second level, the first node is at the first level, and the first transmission gate is off,
in the second period, the clock signal is at the first level, the first node is at the second level, the first transmission gate is on, and the second power signal terminal outputs the second power signal to the second node, and
in the fourth period, the clock signal is at the first level, the first node is at the second level, the first transmission gate is on, and the first power signal terminal outputs the first power signal to the second node.

15. The method of claim 12, wherein the first level is a high level in relation to the second level.

16. A gate driving circuit, comprising at least two cascaded shift register units according to claim 1.

17. A display apparatus, comprising the gate driving circuit according to claim 16.

18. A gate driving circuit, comprising at least two cascaded shift register units according to claim 2.

19. A gate driving circuit, comprising at least two cascaded shift register units according to claim 3.

20. A gate driving circuit, comprising at least two cascaded shift register units according to claim 4.
